(19) United States
(12) Patent Application Publication
(10) Pub. No.: US 2017/0095799 A1
(43) Pub. Date: Apr. 6, 2017

(54) EXHAUST GAS PURIFICATION CATALYST AND METHOD FOR PRODUCING SAME

(71) Applicant: TOYOTA JIDOSHA KABUSHIKI KAISHA, Toyota-shi (JP)

(72) Inventors: Satoshi NAGAO, Gotenba-shi (JP); Yusaku INATOMI, Susono-shi (JP)

(73) Assignee: TOYOTA JIDOSHA KABUSHIKI KAISHA, Toyota-shi (JP)

(21) Appl. No.: 15/261,054

(22) Filed: Sep. 9, 2016

(30) Foreign Application Priority Data
Oct. 2, 2015 (JP) 2015-196808

(51) Int. Cl. B01J 23/652; B01J 21/06; B01D 53/94; B01J 35/02; B01J 37/08; B01J 37/34; B01J 35/00

(52) U.S. Cl. CPC B01J 23/6527; B01J 37/347; B01J 21/066; B01J 35/0006; B01J 35/026; B01J 37/08; B01D 53/9422; B01D 2255/1025; B01D 2255/20776

(57) ABSTRACT

An object of the present invention is to provide an exhaust gas purification catalyst, and a production method thereof, that improves NOx purification performance in a lean atmosphere. The method of the present invention for producing an exhaust gas purification catalyst comprises preparing fine composite-metal particles, each of which contains W and Rh, by carrying out sputtering on a target material containing W and Rh; and supporting the fine composite-metal particles on a powder carrier.

### TECHNICAL FIELD

The present invention relates to an exhaust gas purification catalyst and a method for producing the same.

### BACKGROUND ART

Harmful components such as carbon monoxide (CO), hydrocarbons (HC), and nitrogen oxides (NOx) are contained in the exhaust gas emitted from internal combustion engines, such as gasoline engines or diesel engines, used for automobile.

Consequently, an exhaust gas purification device for degrading and removing these harmful components is typically provided in internal combustion engines, and these harmful components are essentially detoxified by an exhaust gas purification catalyst arranged in the exhaust gas purification device.

A NOx storage reduction catalyst is known as an example of exhaust gas purification catalyst. This NOx storage reduction catalyst is a catalyst that stores NOx present in a lean atmosphere and reduces to nitrogen (N₂) in a stoichiometric and rich atmosphere, and is effectively used by altering exhaust gas components in a lean, stoichiometric, and rich atmosphere (rich spike).

However, there are still problems with purification of NOx in a lean atmosphere, in particular, when attempting to purify NOx in a lean atmosphere only, and various studies have been conducted thereon.

In the exhaust gas purification catalyst of Patent Document 1, catalyst I particles having a particle diameter of 1 nm to 5 nm and catalyst II particles having a particle diameter of 10 nm to 30 nm are supported on a porous body C, and the catalyst I particles and catalyst II particles are formed from a precious metal A particles, or from composite particles comprising a precious metal A and a transition metal B. It is described in this Patent Document 1 to the effect that the porous body C is at least one of compounds selected from Al₂O₃, CeO₂, ZrO₂, SiO₂, TiO₂, silica-alumina, tungsten oxide, and vanadium oxide. Moreover, it is also described in Patent Document 1 to the effect that, in a stoichiometric atmosphere having a theoretical air-fuel ratio, CO purification rate (%) can be determined by calculating NOx purification rate (%), and that as a result thereof, the exhaust gas purification catalyst was determined to have high exhaust gas purification capacity, and particularly a high purification capacity for CO present in exhaust gas.

### PRIOR ART DOCUMENTS

### Patent Documents

[Patent Document 1] Japanese Unexamined Patent Publication No. 2006-021141

### DISCLOSURE OF THE INVENTION

### Problems to be Solved by the Invention

The inventors of the present invention found that, since W and Rh are hardly present at all and/or are hardly compounded at all in fine metal particle (primary fine particle) contained in conventional exhaust gas purification catalysts, the problem occurs, in which it is difficult for W and Rh to mutually approach each other thereby preventing the attaining of a high level of NOx purification performance in a lean atmosphere. Thus, an object of the present invention is to provide an exhaust gas purification catalyst, and a production method thereof, that improves NOx purification performance in a lean atmosphere.

### Means for Solving the Problems

The inventors of the present invention found that the aforementioned problems can be solved by the features indicated below.

(1) A method for producing an exhaust gas purification catalyst, comprising:

preparing fine composite-metal particles, each of which contains W and Rh, by carrying out sputtering on a target material containing W and Rh, and

supporting the fine composite-metal particles on a powder carrier.

(2) The method described in item (1), wherein the target material is a micro-mixed target material obtained by mixing W powder and Rh powder followed by molding and sintering.

(3) An exhaust gas purification catalyst for purifying NOx in a lean atmosphere, comprising:

fine composite-metal particles, each of which contains W and Rh;

wherein, when the fine composite-metal particles in the exhaust gas purification catalyst are analyzed by STEM-EDX, the W content in 70% or more of the fine composite-metal particles based on the total number of particles is within the range of 31% to 138% of the average W content in the fine composite-metal particles.

(4) The exhaust gas purification catalyst described in item (3), wherein it further comprises a powder carrier, and the fine composite-metal particles are supported on the powder carrier.

(5) The exhaust gas purification catalyst described in item (4), wherein the powder carrier is a powder carrier selected from the group consisting of SiO₂, ZrO₂, CeO₂, Al₂O₃, TiO₂, solid solutions thereof, and combinations thereof.

(6) The exhaust gas purification catalyst described in any one of items (3) to (5), wherein the average W content in the fine composite-metal particles is 11 at % to 23 at %.

(7) A method for purifying exhaust gas, comprising:

contacting exhaust gas containing NOx with the exhaust gas purification catalyst described in any one of items (3) to (6) in a lean atmosphere to reduce and purify the NOx as a result thereof.

### Effects of the Invention

According to the present invention, an exhaust gas purification catalyst, and a production method thereof, can be provided that improves NOx purification performance in a lean atmosphere.

### BRIEF DESCRIPTION OF THE DRAWINGS

FIG. 1 is a STEM micrograph of an exhaust gas purification catalyst of Example 1 obtained by analyzing with a scanning transmission electron microscope (STEM) equipped with an energy-dispersive X-ray spectrometer.

FIG. 2 is a graph showing the distribution of the particle diameter (nm) of 10 fine particles randomly extracted from the exhaust gas purification catalyst of Example 1.

FIG. 3 is a graph showing the contents (%) of Rh and W in each of 10 fine particles randomly extracted from the exhaust gas purification catalyst of Example 1.

FIG. 4 is a graph showing the purification rates (%) of NO for exhaust gas purification catalysts of Example 1 and Comparative Examples 1 and 2 when the temperature (° C.) of a test gas in which λ−1.07 (O₂=0.75%) is 400° C., 500° C., and 600° C.

FIG. 5 is a graph indicating the relationship between the temperature (° C.) of a test gas in which λ=1.07 (O₂=0.75%) and NO purification rate (%) for exhaust gas purification catalysts of Examples 1 to 3 and Comparative Example 2.

### DETAILED DESCRIPTION OF THE INVENTION

The following provides a detailed explanation of embodiments of the present invention. Furthermore, the present invention is not limited to the following embodiments and can be modified in various ways within the scope of the gist thereof.

<<Method for Producing Exhaust Gas Purification Catalyst>>

The method for producing an exhaust gas purification catalyst of the present invention comprises a step for preparing fine composite-metal particles, each of which contains W (tungsten) and Rh (rhodium), by carrying out sputtering on a target material containing W and Rh.

In general, nano-sized fine metal particles have an electronic energy structure that differs from that of bulk due to quantum size effect, and exhibit electrical and optical properties that are dependent on particle size. Moreover, there is the possibility that nano-sized fine metal particles having an extremely large specific surface area exhibit high-catalytic activity.

(Co-Impregnation Method)

The so-called co-impregnation method is commonly known as an example of a method for producing such nano-sized fine metal particles by supporting fine composite-metal particles on a powder carrier using a mixed solution containing a plurality of salts of different metal elements.

However, in this conventional co-impregnation method, it is virtually impossible to form fine composite-metal particles in each of which the metal elements of W and Rh are co-present at the nano-level in a specific combination thereof.

Although not limited in principle, this is believed to be due to precursors of W easily and rapidly being hydrolyzed in an aqueous solution, difficulty in enabling precursors of W to be stably present even under strongly acidic conditions, and/or W and Rh respectively and separately precipitating as fine W particles and fine Rh particles.

(Chemical Reduction Method)

In addition, another known method for producing fine composite-metal particles, each of which contains metal elements is the chemical reduction method, in which a reducing agent such as an alcohol is added to a mixed solution containing salts of each metal element that composes each of the fine composite-metal particles, and ions of each metal element contained in the mixed solution are simultaneously reduced while carrying out heating and the like as necessary.

However, since methods for producing fine composite-metal particles that use a reducing agent in the manner described above comprise a step for reducing salts or ions of each metal element dissolved in the solution, in the case there are differences in ease with which the salts or ions of each metal element are reduced, such as differences in the oxidation-reduction potential thereof, it becomes extremely difficult to form fine composite-metal particles in each of which each metal element is co-present at the nano-level.

In providing a more detailed explanation thereof, in the case of, for example, adding a reducing agent such as an alcohol to a mixed solution containing W ions and Rh ions, instead of the W ions and Rh ions being simultaneous reduced by the reducing agent, the Rh ions are believed to be preferentially reduced and grown into particles since they are more easily reduced than W ions.

As a result, hardly any fine composite-metal particles are formed in each of which W and Rh are co-present at the nano-level, while it is believed that fine W particles and fine Rh particles are, instead, formed separately or fine W particles per se are essentially not formed.

(Other Methods)

Even in the case of applying other methods such as a co-precipitation method and a citric acid complex method, it is believed to be difficult to obtain fine composite-metal particles in each of which W and Rh are co-present at the nano-level for the same reasons as those described with respect to the aforementioned co-impregnation method and the like.

Thus, in the case of employing a conventional wet process such as the co-impregnation method or chemical reduction method, hardly any fine composite-metal particles in each of which W and Rh form a complex are able to be produced. Consequently, it is believed to be unable to produce an exhaust gas purification catalyst that improves NOx purification performance in a lean atmosphere.

(Method of Present Invention)

In contrast, fine composite-metal particles in the exhaust gas purification catalyst produced according to the method of the present invention are produced by applying a so-called dry process in which sputtering is carried out on a target material containing W and Rh. Thus, by applying the method of the present invention, fine composite-metal particles, each of which contains W and Rh, can be produced while avoiding problems that occur in the aforementioned wet processes.

In addition, the method of the present invention further comprises a step for supporting the fine composite-metal particles on a powder carrier during or after sputtering.

Any method may be employed for the method used to support the fine composite-metal particles on the powder carrier. Examples of a method for supporting the fine composite-metal particles on the powder carrier may include, for example, directly supporting the fine composite-metal particles on the powder carrier by carrying out the aforementioned sputtering above a powder carrier.

<Target Material>

According to the method of the present invention, the target material contains W and Rh.

Any suitable material can be used for the target material containing W and Rh, and although there are no particular limitations thereon, examples of materials that can be used include a target material in which W and Rh are alternately arranged, and a micro-mixed target material in which W powder and Rh powder are mixed followed by molding and sintering and the like.

Furthermore, the degree of the ease of sputtering against each metal during sputtering varies for each metal element thereof. Thus, the composition ratio of W and Rh in the target material is determined in consideration of the degree of the ease with which these metal elements are sputtered. Moreover, the composition ratio of W powder and Rh powder in mixing thereof may be correlated or proportional to the composition ratio of W and Rh in each of the fine composite-metal particles formed by sputtering.

(Alternately Arranged Target Material)

A disk-shaped material in which W and Rh are alternately arranged in a radiating pattern, for example, can be used as a target material in which W and Rh are alternately arranged. According to this type of disk-shaped target material, fine composite-metal particles each having a desired composition ratio of W and Rh can be prepared comparatively easily by suitably altering the areas or area ratio of W and Rh.

(Micro-Mixed Target Material)

In the case of employing a micro-mixed target material, fine composite-metal particles can be formed that have high uniformity with respect to the composition ratio of W and Rh.

<Sputtering>

According to the method of the present invention, sputtering is carried out on a target material containing W and Rh in order to prepare fine composite-metal particles, each of which contains W and Rh.

This sputtering can be carried out using any suitable conditions for parameters such as gas components, gas pressure, sputtering current, voltage, duration, and number of cycles.

Examples of gas components used in sputtering may include an inert gas such as helium (He), neon (Ne), argon (Ar), krypton (Kr), xenon (Xe), nitrogen (N₂), and a combination thereof. Among these, Ar or N₂ is preferable based on its handling ease.

Although the gas pressure used during sputtering can be freely selected provided it allows the generation of plasma, in general, the gas pressure is preferably 20 Pa or lower.

The current and voltage used during sputtering may be suitably set corresponding to such factors as the composition of the target material or the sputtering device used.

Although there are no particular limitations on the duration of sputtering and may be suitably set in consideration of such factors as the desired deposited amount of fine composite-metal particles or other parameters, it can be set to, for example, several ten minutes to several hours or several tens of hours.

The number of sputtering cycles is such that sputtering can be carried out by dividing into a plurality of cycles at an interval of every few hours, in order to prevent the fine composite-metal particles, formed from the target material, from reaching a high temperature occurring sintering and the like thereof as a result of carrying out sputtering for an extended period of time. Furthermore, sintering refers to a phenomenon in which fine metal particles undergo particle growth at a temperature equal to or lower than the melting point thereof.

<Other>

The following description of the exhaust gas purification catalyst of the present invention can be referred to with respect to the aforementioned constituents.

<<Exhaust Gas Purification Catalyst>>

The exhaust gas purification catalyst of the present invention comprises fine composite-metal particles, each of which contains W and Rh, and when the fine composite-metal particles in the exhaust gas purification catalyst are analyzed by STEM-EDX, the W content in 70% or more of the fine composite-metal particles based on the total number of particles is within the range of 31% to 138% of the average W content in the fine composite-metal particles.

Although not limited in theory, the reason for the exhaust gas purification catalyst of the present invention being able to improve NOx purification performance in a lean atmosphere is believed to be due to W, having superior NOx adsorption capacity, and Rh, having superior NOx reduction capacity, forming a complex that enables them to mutually approach at the nano-level, thereby enabling the NOx adsorbed to the W to be rapidly reduced to N₂ by the Rh.

Furthermore, the aforementioned improvement in NOx purification performance can be demonstrated as long as the W and Rh in the fine composite-metal particles mutually approach at the nano-level, and even in the case, for example, the fine composite-metal particles are partially converted to an oxide, the exhaust gas purification catalyst of the present invention is able to demonstrate improved NOx purification performance.

In addition, the exhaust gas purification catalyst of the present invention further optionally comprises a powder carrier, and the fine composite-metal particles are supported on this powder carrier.

In the case the fine composite-metal particles are supported on this powder carrier, the contact surface between exhaust gas and the fine composite-metal particles increases due to the large specific surface area of the powder carrier. As a result, performance of the exhaust gas purification catalyst can be improved.

<Fine Composite-Metal Particles>

Each of the fine composite-metal particles contains W and Rh.

If the particle diameter of the fine composite-metal particles is excessively large, specific surface area becomes small and the number of NOx adsorption sites on W and the number of NOx active sites on Rh decrease, which may prevent the ultimately obtained exhaust gas purification catalyst from being able to achieve adequate NOx reduction capacity.

In addition, if the particle diameter of the fine composite-metal particles is excessively small, there is the possibility of the exhaust gas purification catalyst losing activity.

From the viewpoint of efficiently reducing NOx, the particle diameter of the fine composite-metal particles is preferably within the range of 1 nm to 10 nm, more preferably within the range of 1 nm to 5 nm, and even more preferably within the range of 1.4 nm to 3.4 nm.

Moreover, examples of the average particle diameter of fine composite-metal particles may be particle diameters of greater than 0 nm, 1 nm or more, or 2 nm or more. In addition, examples of the average particle diameter of the fine composite-metal particles may be particle diameters of 100 nm or less, 70 nm or less, 40 nm or less, 10 nm or less, 7 nm or less, 5 nm or less, 4 nm or less, or 3 nm or less.

From the viewpoint of efficiently reducing NOx in particular, the average particle diameter of the fine composite-metal particles is preferably within the range of 1 nm to 5 nm, more preferably within the range of 1 nm to 4 nm, and even more preferably within the range of 2 nm to 3 nm.

Moreover, the average particle diameter of 70% or more, 75% or more, 80% or more, 85% or more, 90% or more, or 95% or more based on the total number of particles may be within the range of 30% to 180%, 40% to 170%, 50% to 160%, or 63% to 155% of the average particle diameter of fine composite-metal particles.

As a result of using fine composite-metal particles having such a particle diameter as a catalyst component, W and Rh can be allowed to be co-present at the nano-level, thereby enabling W to effectively demonstrate NOx adsorption effects and Rh to effectively demonstrate NOx reduction capacity. Thus, an exhaust gas purification catalyst can be obtained that improves NOx purification performance in a lean atmosphere.

Furthermore, in the present invention, unless specifically indicated otherwise, “average particle diameter” refers to the arithmetic average of measured values obtained in the case of measuring the equivalent circle diameter (Heywood diameter) of 10 or more randomly selected particles using a means such as a scanning transmission electron microscope (STEM).

In addition, in the present invention, unless specifically indicated otherwise, “based on the total number of particles” refers to a ratio of the number of fine composite-metal particles having a specific composition to the total number of fine composite-metal particles of an exhaust gas purification catalyst. Even a single composite fine metal particle of the exhaust gas purification catalyst of the present invention has superior exhaust gas purification capacity. Thus, in the case at least 70% or more of the fine composite-metal particles based on the total number of particles have a preferable composition, it is understood that the exhaust gas purification catalyst of the present invention may be able to purify a larger amount of exhaust gas in terms of per unit specific mass, specific volume, or specific surface area thereof.

In the case the average W content of the fine composite-metal particles is 11 at % to 23 at %, the number of NOx active sites of Rh can be adequately ensured while adequately obtaining the NOx adsorption effects of W.

Thus, the average W content of the fine composite-metal particles is preferably 11 at % or more, 12 at % or more, 13 at % or more, 14 at % or more, or 15 at % or more; and 23 at % or less, 21 at % or less, 20 at % or less, 19 at % or less, or 18 at % or less.

Moreover, the W content of 70% or more, 75% or more, 80% or more, 85% or more, 90% or more or 95% or more of the fine composite-metal particles based on the total number of particles may be within the range of 31% to 138% of the average W content in the fine composite-metal particles.

Namely, the range of the aforementioned average W content of the fine composite-metal particles achieved according to the method of the present invention is comparatively narrow, indicating that the composition of the fine composite-metal particles is comparatively uniform. Consequently, Rh efficiently demonstrates NOx purification capacity while maintaining the number of NOx adsorption sites of W, and as a result thereof, an exhaust gas purification catalyst can be obtained that has remarkably improved NOx reduction capacity.

In addition, “W content” in the present invention refers to the ratio of the number of W atoms to the total number of W atoms and Rh atoms contained in the fine composite-metal particle. For example, “W content” in the present invention can be calculated by analyzing fine composite-metal particle using an optical method such as STEM-EDX. In addition, “average W content” in the present invention can be calculated by determining the arithmetic average of the W content of particles randomly extracted from the exhaust gas purification catalyst.

<Powder Carrier>

The powder carrier supports the fine composite-metal particles.

Although there are no particular limitations thereon, an arbitrary metal oxide typically used as a powder carrier in the technical field of exhaust gas purification catalysts can be used for the powder carrier on which the fine composite-metal particles are supported.

Examples of such powder carriers may include silica (SiO₂), zirconia (ZrO₂), ceria (CeO₂), alumina (Al₂O₃), titania (TiO₂), solid solutions thereof, and combinations thereof.

Acidic carriers such as SiO₂ have favorable compatibility with the catalyst metal that reduces NOx. Basic carriers such as MgO have favorable compatibility with K and Ba that store NOx. ZrO₂ is able to efficiently reduce NOx by inhibiting sintering of other powder carriers at high temperatures at which sintering of other powder carriers occurs, and forming H₂ by undergoing a steam reforming reaction by combining with a catalyst metal in the form of Rh. CeO₂ can be preferably used in three-way catalysts as a result of having the effects of storing oxygen in a lean atmosphere and releasing oxygen in a rich atmosphere. Acid-base carrier such as Al₂O₃ can be used to efficiently store and reduce NOx. TiO₂ is able to demonstrate the effect of inhibiting sulfur poisoning of catalyst metals.

Although there are no particular limitations thereon, the supported amount of fine composite-metal particles supported by the powder carrier may be typically 0.01 parts by weight or more, 0.05 parts by weight or more, 0.1 parts by weight or more, 0.5 parts by weight or more, or 1 part by weight or more; and 5 parts by weight or less, 3 parts by weight or less, or 1 part by weight or less based on 100 parts by weight of the powder carrier.

<Other>

The fine composite-metal particles used in the exhaust gas purification catalyst of the present invention can be produced by the aforementioned method of the present invention, and can be applied to the method of the present invention indicated below.

<<Exhaust Gas Purification Method>>

The method of the present invention for purifying exhaust gas comprises contacting an exhaust gas containing NOx with the aforementioned exhaust gas purification catalyst of the present invention in a lean atmosphere to reduce and purify the NOx as a result thereof.

The method of the present invention is preferably applied to an internal combustion engine that operates in a lean atmosphere. This is because HC and CO are easily oxidized and purified in a lean-burning atmosphere, while there is the difficulty of reducing and purifying NOx, thereby resulting in the generation of large amounts of NOx.

An arbitrarily selected method can be employed for the method used to contact exhaust gas containing NOx with the exhaust gas purification catalyst of the present invention in a lean atmosphere.

Although the following provides a more detailed explanation of the present invention by referring to the examples indicated below, it goes without saying that the scope of the present invention is not limited by these examples.

### EXAMPLES

### Example 1

### Sputtering Method: Synthesis of Catalyst Containing Fine Rh-W Composite-Metal Particles

<Preparation of Target Material>

W powder and Rh powder were mixed at a composition ratio of 30:70 followed by molding and sintering the resulting mixture to prepare a micro-mixed target material containing W and Rh.

<Preparation of Exhaust Gas Purification Catalyst>

The target material and a powder carrier in the form of ZrO₂ powder were arranged in a sputtering device filled with an Ar atmosphere, and a voltage was applied to an electrode pair installed in the sputtering device to generate plasma between the electrodes followed by carrying out sputtering as a result thereof. Following sputtering, ZrO₂ powder having fine Rh-W composite-metal particles supported thereon was removed from the sputtering device to prepare an exhaust gas purification catalyst.

### Examples 2 and 3

Exhaust gas purification catalysts of Example 2 (W:Rh=10:90) and Example 3 (W:Rh=50:50) were prepared in the same manner as Example 1 with the exception of changing the composition ratio of W powder and Rh powder to 10:90 or 50:50 in the preparation of the aforementioned target material.

### Comparative Example 1

### Sputtering: Synthesis of Catalyst Containing Fine Rh-Metal Particles and Fine W-Metal Particles

An exhaust gas purification catalyst of Comparative Example 1 was prepared in the same manner as Example 1 with the exception of preparing a Rh target material containing only Rh powder and a W target material containing only W powder in the preparation of the aforementioned target material, and alternately sputtering these target materials.

### Comparative Example 2

### Sputtering: Synthesis of Catalyst Containing only Fine Rh-Metal Particles

An exhaust gas purification catalyst of Comparative Example 2 was prepared in the same manner as Example 1 with the exception of preparing a Rh target material containing only Rh powder in the preparation of the aforementioned target material, and using this target material.

<<Evaluation>>

<Evaluation by ICP-MS>

The exhaust gas purification catalysts of Examples 1 to 3 and Comparative Examples 1 and 2 were analyzed by inductively coupled plasma mass spectrometry (ICP-MS). The concentration as percent by weight of Rh based on ZrO₂ of each example, and the composition ratio of W and Rh in the exhaust gas purification catalyst of each example were evaluated on the basis of this analysis.

As a result, the concentration as percent by weight of Rh based on ZrO₂ was about 1% by weight in each example.

<Evaluation by STEM-EDX>

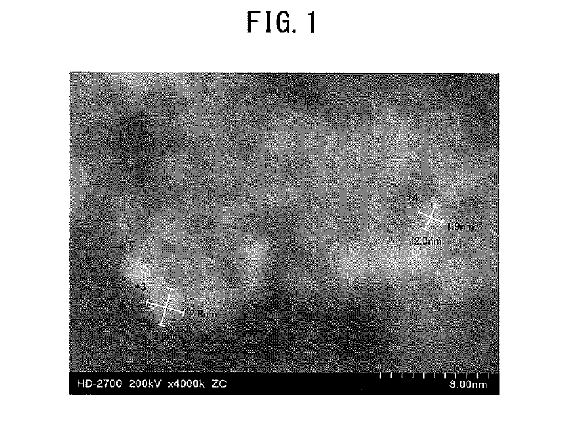

STEM-EDX was applied to the exhaust gas purification catalysts produced in Examples 1 to 3 and Comparative Examples 1 and 2, fine metal particles were extracted from the STEM micrographs in the form of measurement points as a result thereof. The form of the fine metal particles at each measurement point, the composition ratio of W and Rh in the target materials, the composition ratio of W and Rh in the fine metal particles, and the particle diameter (average particle diameter) were evaluated. The results for Example 1 are shown in Table 1 and FIGS. 1 to 3, and furthermore, the results for the other examples are shown in Table 1.

TABLE 1

| | | Composition | Average Composite | Average |
|---|---|---|---|---|
| | | ratio of W | Ratio of W | Particle |
| | | and Rh in | and Rh in | Diam- |
| | Form of Fine | Target | Fine Metal | eter |
| | Metal Particles | Material | Particles | (nm) |
| Exam- | Fine composite- | 30:70 | 13:87 | 2.2 |
| ple 1 | metal particles | | | |
| | of W and Rh | | | |
| Exam- | Fine composite- | 10:90 | 11:89 | 1.9 |
| ple 2 | metal particles | | | |
| | of W and Rh | | | |
| Exam- | Fine composite- | 50:50 | 23:77 | 2.3 |
| ple 3 | metal particles | | | |
| | of W and Rh | | | |
| Comp. | Fine Rh-metal | 0:100 or | 0:100 | 1.9 |
| Ex. 1 | particles* | 100:0 | | |
| Comp. | Fine Rh-metal | 0:100 | 0:100 | 2.2 |
| Ex. 2 | particles | | | |

Furthermore, “Fine Rh-metal particles*” in Table 1 indicates that fine composite-metal particles each containing W and Rh, and fine W-metal particles were unable to be detected in the STEM-EDX analysis on the fine metal particles of the exhaust gas purification catalyst of Comparative Example 1. This is believed to be due to W reacting with oxygen in the air causing it to be converted to an oxide thereof in the form of an amorphous.

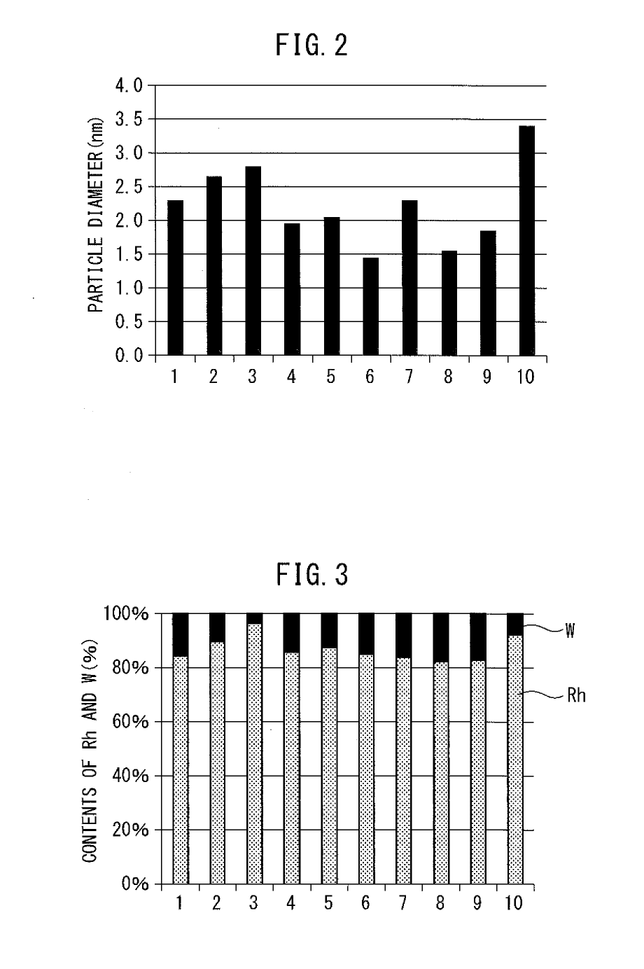

FIG. 1 depicts a STEM micrograph of the exhaust gas purification catalyst of Example 1 analyzed by STEM-EDX. In addition, FIG. 2 is a graph showing the distribution of the particle diameter (nm) of 10 fine particles randomly extracted from the exhaust gas purification catalyst of Example 1. Moreover, FIG. 3 is a graph showing the contents (%) of Rh and W in each of 10 fine particles randomly extracted from the exhaust gas purification catalyst of Example 1.

With reference to FIGS. 1 and 2, fine composite-metal particles having a particle diameter within the range of 1.4 nm to 3.4 nm were determined to be dispersed on the surface of a powder carrier in the form of ZrO₂. More specifically, the average particle diameter of the fine composite-metal particles was determined to be about 2.2 nm, and the particle diameter of the fine composite-metal particles was determined to be within a range of 63% to 155% of the average particle diameter of fine composite-metal particles.

With reference to FIG. 3, the W content (%) in the fine composite-metal particles was determined to be within the range of 4 at % to 18 at %. Namely, the Rh content of the fine composite-metal particles was determined to be from 82 at % to 96 at %. Thus, on the basis of FIG. 3, the average W content of the fine composite-metal particles was determined to be about 13%, and the W content in the fine composite-metal particles was determined to be within the range of 31% to 138% of the average W content in the fine composite-metal particles.

In other words, in the case of sputtering using a micro-mixed target material containing W and Rh, fine composite-metal particles were determined to be able to be formed that have a high degree of uniformity with respect to the composition ratio of W and Rh.

Thus, on the basis of FIGS. 1 to 3 and Table 1, the contents of W and Rh in fine composite-metal particles in the exhaust gas purification catalyst of Example 1 were determined to be roughly uniform in the fine composite-metal particles, and the fine composite-metal particles were determined to be dispersed on the powder carrier at a roughly uniform particle diameter.

Furthermore, with reference to Table 1, in the exhaust gas purification catalyst of Example 1, a difference was determined to be present between the composition ratio of W and Rh (30:70) in the target materials, and the ratio of the average contents of W and Rh (13:87) in the fine composite-metal particles. This is believed to be due to reasons such as differences between the degree of the ease of sputtering against Rh and the degree of that against W, and the generation of W oxides. Moreover, it is believed that the same can be applied to Examples 2 and 3.

<Evaluations 1 and 2 of NOx Purification by Exhaust Gas Purification Catalyst>

(Evaluation Preparations)

Powders of the exhaust gas purification catalysts prepared in Examples 1 to 3 and Comparative Examples 1 and 2 were pressed at a press pressure of 2 L/cm² to form into pellets followed by further crushing the pelletized catalysts into granular form. The granular catalysts were then used as samples.

A gas flow type of catalyst evaluation device was used in an evaluation of NOx purification by an exhaust gas purification catalyst. More specifically, the composition of a test gas obtained after contacting with a sample was measured by applying infrared spectroscopy.

Furthermore, the weight of the aforementioned sample was set at 0.4 g, and the composition of the test gas consisted of 0.65% CO, 3000 ppmC (1000 ppm) C₃H₆, 1500 ppm NO, 0.75% O₂, 3% H₂O, and 10% CO₂ with the balance consisting of N₂. The λ value of this test gas was equivalent to 1.07 (a lean atmosphere). The λ value, which is an indicator of the intensity of a rich atmosphere and a lean atmosphere, is defined as “oxidant equivalent/reductant equivalent”. For example, a rich atmosphere, a stoichiometric atmosphere, and a lean atmosphere can be represented as λ<1, λ=1 and λ>1, respectively.

In addition, the flow rate of the test gas was set to 1 L/min and the space velocity (SV) was set to 125,000 h⁻¹. Furthermore, space velocity refers to the value obtained by dividing the flow rate (volume/h) of the test gas by the volume of the sample.

(Evaluation 1 of NOx Purification by Exhaust Gas Purification Catalyst)

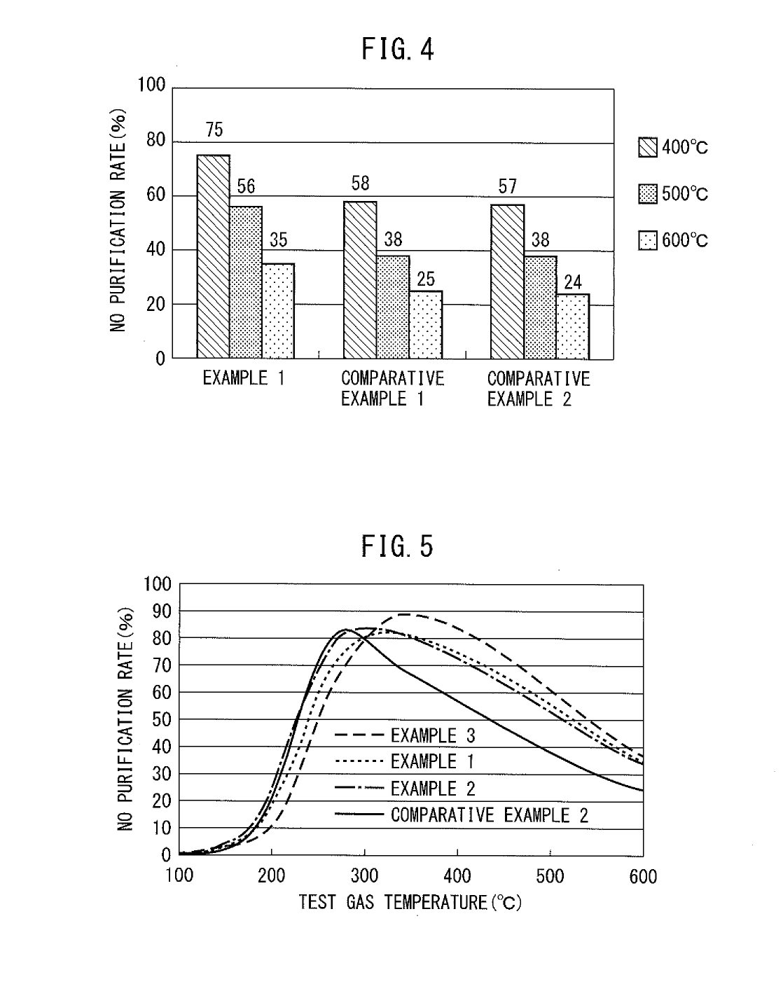

NO purification rates (%) were measured for the exhaust gas purification catalysts of Example 1 and Comparative Examples 1 and 2 when the temperature (° C.) of the sample gas was 400° C., 500° C., and 600° C. The results are shown in FIG. 4.

Furthermore, NO purification rate (%) can be represented by the following Formula (I):

NO purification rate (%)={(NOᵢₙ−NOₒᵤₜ)/(NOᵢₙ)×100 (I)

(wherein,

NOᵢₙ: Concentration of NO flowing into catalyst evaluation device,

NOₒᵤₜ: Concentration of NO flowing out of catalyst evaluation device).

FIG. 4 is a graph showing the purification rates (%) of NO for exhaust gas purification catalysts of Example 1 and Comparative Examples 1 and 2 when the temperature (° C.) of a test gas in which λ−1.07 (O₂=0.75%) is 400° C., 500° C. and 600° C.

On the basis of FIG. 4, NO purification rates (%) of the exhaust gas purification catalyst of Example 1 were determined to be about 1.5 times higher than that of Comparative Examples 1 and 2 at each of the temperatures of 400° C., 500° C., and 600° C. It is believed that, in the exhaust gas purification catalyst of Example 1, W having superior NOx adsorption capacity and Rh having superior NOx reduction capacity form a complex and mutually approach at the nano-level, thereby enabling the NOx adsorbed to W to be rapidly reduced to N₂ by Rh.

Thus, the NOx purification capacity of the exhaust gas purification catalyst of Example 1 in a lean atmosphere was determined to be higher than that of Comparative Examples 1 and 2 in a lean atmosphere.

(Evaluation 2 of NOx Purification by Exhaust Gas Purification Catalyst)

Temperature (° C.) of a test gas and NO purification rate (%) were measured for the exhaust gas purification catalysts of Examples 1 to 3 and Comparative Example 2. The results are shown in FIG. 5.

FIG. 5 is a graph indicating the relationship between the temperature (° C.) of a test gas in which λ=1.07 (O₂=0.75%) and NO purification rate (%) for exhaust gas purification catalysts of Examples 1 to 3 and Comparative Example 2.

On the basis of FIG. 5, NOx purification rates of the exhaust gas purification catalysts of Examples 1 to 3 were determined to be higher than that of Comparative Example 2 at high temperatures of about 300° C. or higher. In addition, It is seen that the more average W content of the fine composite-metal particles in the exhaust gas purification catalysts increased, the more NOx purification rates increased at high temperatures of about 300° C. or higher.

Although not limited in any theory, it is believed that, in an exhaust gas purification catalyst having fine composite-metal particles each containing Rh and W, a reaction mechanism appears that selectively reduces NOx under conditions of a high temperature (light-off temperature) and a lean atmosphere.

Although the preceding has provided a detailed description of preferred embodiments of the present invention, it should be understood by a person having ordinary skill in the art that the manufacturer, grade or quality and the like of devices, equipment and chemicals and so forth used in the present invention can be modified without deviating from the scope of claim.

What is claimed is:

1. A method for producing an exhaust gas purification catalyst, comprising:
preparing fine composite-metal particles, each of which contains W and Rh, by carrying out sputtering on a target material containing W and Rh, and
supporting the fine composite-metal particles on a powder carrier.

2. The method according to claim 1, wherein the target material is a micro-mixed target material obtained by mixing W powder and Rh powder followed by molding and sintering.

3. An exhaust gas purification catalyst for purifying NOx in a lean atmosphere, comprising:
fine composite-metal particles, each of which contains W and Rh;
wherein, when the fine composite-metal particles in the exhaust gas purification catalyst are analyzed by STEM-EDX, the W content in 70% or more of the fine composite-metal particles based on the total number of particles is within the range of 31% to 138% of the average W content in the fine composite-metal particles.

4. The exhaust gas purification catalyst according to claim 3, wherein it further comprises a powder carrier, and the fine composite-metal particles are supported on the powder carrier.

5. The exhaust gas purification catalyst according to claim 4, wherein the powder carrier is a powder carrier selected from the group consisting of SiO₂, ZrO₂, CeO₂, Al₂O₃, TiO₂, solid solutions thereof, and combinations thereof.

6. The exhaust gas purification catalyst according to claim 3, wherein the average W content in the fine composite-metal particles is 11 at % to 23 at %.

7. A method for purifying exhaust gas, comprising:
contacting exhaust gas containing NOx with the exhaust gas purification catalyst according to claim 3 in a lean atmosphere to reduce and purify the NOx as a result thereof.

8. The exhaust gas purification catalyst according to claim 4, wherein the average W content in the fine composite-metal particles is 11 at % to 23 at %.

9. The exhaust gas purification catalyst according to claim 5, wherein the average W content in the fine composite-metal particles is 11 at % to 23 at %.

10. A method for purifying exhaust gas, comprising:
contacting exhaust gas containing NOx with the exhaust gas purification catalyst according to claim 4 in a lean atmosphere to reduce and purify the NOx as a result thereof.

11. A method for purifying exhaust gas, comprising:
contacting exhaust gas containing NOx with the exhaust gas purification catalyst according to claim 5 in a lean atmosphere to reduce and purify the NOx as a result thereof.

12. A method for purifying exhaust gas, comprising:
contacting exhaust gas containing NOx with the exhaust gas purification catalyst according to claim 6 in a lean atmosphere to reduce and purify the NOx as a result thereof.

13. A method for purifying exhaust gas, comprising:
contacting exhaust gas containing NOx with the exhaust gas purification catalyst according to claim 8 in a lean atmosphere to reduce and purify the NOx as a result thereof.

14. A method for purifying exhaust gas, comprising:
contacting exhaust gas containing NOx with the exhaust gas purification catalyst according to claim 9 in a lean atmosphere to reduce and purify the NOx as a result thereof.
